(19) United States
(12) Patent Application Publication
(10) Pub. No.: US 2006/0286456 A1
(43) Pub. Date: Dec. 21, 2006

(54) NANO-LITHIUM-ION BATTERIES AND METHOS FOR MANUFACTURING NANO-LITHIUM-ION BATTERIES

(76) Inventors: ZHIGUO FU, Harbin (CN); HONGJUN SI, Harbin (CN); GUOPENG GAO, Harbin (CN)

Correspondence Address: Jones Day, 222 East 41st Street, New York, NY, 10017, US

(21) Appl. No.: 11/425,304

(22) Filed: Jun. 20, 2006

Related U.S. Application Data
(60) Provisional application No. 60/692,418, filed on Jun. 20, 2005.

(51) Int. Cl. H01M 4/48; H01M 4/62; H01M 2/16

(52) U.S. Cl. 429/231.1; 429/231.5; 429/217; 29/623.5; 429/247

(57) ABSTRACT

The disclosure describes nano-lithium-ion batteries having a cathode, an anode including lithium titanium oxide nanoparticles, a separator including silicon dioxide nanoparticles and an electrolyte. In a preferred embodiment, the cathode is composed of 70-95 wt % lithium cobalt oxide, 1-6 wt % of a conductive carbon, and a synthetic resin including at least one thermoplastic; the anode is composed of 75-90 wt % lithium titanium oxide nanoparticles, 1-5 wt % of a conductive carbon, and a synthetic resin including at least one thermoplastic; and the separator is composed of silicon dioxide nanoparticles and a synthetic resin comprising at least one thermoplastic. The disclosure also describes methods of manufacturing the nano-lithium-ion batteries.

### CROSS-REFERENCE TO RELATED APPLICATIONS

This application claims priority to U.S. provisional application No. 60/692,418, filed on Jun. 20, 2005, the entire contents of which is incorporated herein by reference.

### FIELD OF THE INVENTION

The present disclosure is directed to nano-lithium-ion batteries and methods for manufacturing nano-lithium-ion batteries.

### BACKGROUND OF THE INVENTION

Various companies have developed lithium-ion batteries. For example, Valence Technology, Inc. offers a lithium-ion polymer battery, some of which is based on patents acquired from Telcordia Technologies, formerly Bell Communications Research, Inc. (Bellcore). Sony Corp. based in Shinagawa, Tokyo, Japan and BYD Co. Ltd., based in Shenzhen, Guangdong, China also manufacture different types of lithium-ion batteries.

One type of rechargeable lithium-based battery available on the market is the lithium-ion-polymer battery. The lithium-ion-polymer battery differs from the conventional lithium-ion battery in that a solid polymer composite electrolyte (e.g., based in polyacrylonitrile) is used in place of the lithium salt/organic solvent electrolyte. Many commercialized technologies include polyvinylidene fluoride gelled with conventional salts and solvents, such as EC/DMC/DEC, etc. The various technologies also differ in the cathode composition. For example, the cathode of the Bellcore battery may include lithium manganate (LiMn₂O₄).

The lithium-ion batteries are considered more environmentally friendly than other battery technologies, and require much lower manufacturing costs compared to other types of batteries. An advantage of lithium-ion batteries over nickel-cadmium and nickel-metal-hydride batteries is that the rate of self discharge is much lower.

Two keys limitations of lithium-ion battery technology available to date are safety concerns and the undesirable length of time needed to charge and discharge the battery. Furthermore, the complexity of lithium-ion battery technology and the high costs associated with their manufacture are factors that complicate the development of lithium-ion batteries.

The present disclosure provides nano-lithium-ion batteries that overcome the safety concerns of the current lithium-ion battery. The nano-lithium-ion batteries disclosed herein exhibit reduced current charge/discharge time and reduced manufacturing costs. The present disclosure also provides methods for manufacturing the nano-lithium-ion batteries. In particular, the methods of the invention allow the manufacture of batteries in varied shapes to conform to a variety of applications, including portable electronic platforms. The methods of the present invention provide for cost advantages in battery manufacture, and provide batteries with increased safety and flexibility, and superior performance.

### SUMMARY OF THE INVENTION

In a first aspect, the present invention provides nano-lithium-ion batteries. In a first embodiment according to the first aspect, the nano-lithium-ion battery includes an anode comprising lithium titanium oxide nanoparticles, a cathode, a separator, and an electrolyte. In a second embodiment according to the first aspect, the nano-lithium-ion battery includes an anode, a cathode, a separator comprising silicon dioxide nanoparticles, and an electrolyte. In a third embodiment according to the first aspect, the nano-lithium-ion battery includes an anode comprising lithium titanium oxide nanoparticles and a conductive carbon, a cathode comprising lithium cobalt oxide and a conductive carbon, a separator comprising silicon dioxide nanoparticles, and an electrolyte.

In a fourth embodiment according to the first aspect, the nano-lithium-ion battery includes an anode comprising about 75 weight percent to about 90 weight percent lithium titanium oxide nanoparticles, about 1 weight percent to about 5 weight percent of a conductive carbon, and a synthetic resin comprising at least one thermoplastic; a cathode comprising about 70 weight percent to about 95 weight percent lithium cobalt oxide, about 1 weight percent to about 6 weight percent of a conductive carbon, and a synthetic resin comprising at least one thermoplastic; a separator comprising about 2 weight percent to about 5 weight percent of silicon dioxide nanoparticles, and a synthetic resin comprising at least one thermoplastic; and an electrolyte.

In a second aspect, the present invention provides methods of making nano-lithium-ion batteries. In a first embodiment according to the second aspect, the method of making the nano-lithium-ion battery includes the steps of: (a) hot laminating a cathode assembly comprising an aluminum foil material and a carrier coated with a slurry of a cathode material; (b) hot laminating an anode assembly comprising a cuprum foil and a carrier coated with a slurry of an anode material, wherein the anode material comprises lithium titanium oxide nanoparticles; (c) hot laminating a unit comprising the anode assembly, the cathode assembly, and a separator, wherein the separator comprises silicon dioxide nanoparticles; and (d) introducing an electrolyte into the unit, thereby providing a nano-lithium-ion battery.

In a second embodiment according to the second aspect, the method of making the nano-lithium-ion battery includes the steps of: (a) punching a carrier coated with an anode slurry to conform to a pre-determined battery shape, wherein the anode slurry comprises lithium titanium oxide nanoparticles; (b) assembling the shaped anode slurry with a cuprum foil material to form a cathode assembly; (c) treating the anode assembly using hot lamination; (d) punching a carrier coated with a cathode slurry to conform to a pre-determined battery shape; (e) assembling the shaped cathode slurry with an aluminum foil material to form a cathode assembly; (f) treating the cathode assembly using hot lamination; (g) hot laminating a unit comprising the anode assembly, the cathode assembly, and a separator, wherein the separator comprises silicon dioxide nanoparticles; and (h) introducing an electrolyte into the unit, thereby providing a nano-lithium-ion battery.

In a third embodiment according to the second aspect, the method of making the nano-lithium-ion battery includes the steps of: a) providing a shaped cuprum foil; (b) treating the shaped cuprum foil with a treatment slurry to provide a treated cuprum foil, wherein the treatment slurry comprises a glue; (c) assembling the treated cuprum foil with a shaped anode material to fora an ode assembly, wherein the shaped anode material comprises lithium titanium oxide nanoparticles; (d) hot laminating the anode assembly at a temperature approximately equal to or greater than the melting temperature of the glue; (e) providing a shaped aluminum foil; (f) treating the shaped aluminum foil with a treatment slurry to provide a treated aluminum foil, wherein the treatment slurry comprises a glue; (g) assembling the treated aluminum foil with a shaped cathode material to form a cathode assembly; (h) hot laminating the cathode assembly at a temperature approximately equal to or greater than the melting temperature of the glue; (i) hot laminating a unit comprising the anode assembly, the cathode assembly, and a separator at a temperature approximately equal to or lower than the melting temperature of the glue, wherein the separator comprises silicon dioxide nanoparticles; and (j) introducing an electrolyte into the unit, thereby providing a nano-lithium-ion battery.

### BRIEF DESCRIPTION OF THE DRAWINGS

FIGS. 1A-1D illustrate nano-lithium-ion batteries according to exemplary embodiments of the invention. FIG. 1A illustrates a cross section of a nano-lithium-ion battery including a single unit. FIG. 1B illustrates a cross section of a nano-lithium-ion battery including a multi-layer laminate structure. FIG. 1C illustrates a nano-lithium battery having a coin-type configuration. FIG. 1D illustrates another embodiment of the nano-lithium battery.

FIGS. 2A and 2B illustrate a technical flow chart for steps in making a nano-lithium-ion battery according to an exemplary embodiment of the invention, where the letters “TMM” refer to “treatment material mixing.”

### DETAILED DESCRIPTION OF THE PREFERRED EMBODIMENTS

The nano-lithium-ion batteries disclosed herein are desirable because they can be made into specialized, thin electro-active laminated films. An advantage of the nano-lithium-ion battery technology described herein is that a manufacturer would be able to shape a battery to just about any morphology they desire, which is important to developing or emerging technology. For example, mobile phone manufacturers can manufacture batteries that conform to the progressively smaller, thinner, and lighter phones that are being placed on the market.

Nano-Lithium-lon Battery

In a first embodiment, the nano-lithium-ion battery includes an anode comprising lithium transition metal oxide nanoparticles, a cathode, a separator, and an electrolyte. In a second embodiment, the nano-lithium-ion battery includes an anode, a cathode, a separator comprising silicon dioxide nanoparticles, and an electrolyte. In a third embodiment, the nano-lithium-ion battery includes an anode comprising lithium titanium oxide nanoparticles and a conductive carbon, a cathode comprising lithium cobalt oxide and a conductive carbon, a separator comprising silicon dioxide nanoparticles, and an electrolyte.

Conductive carbons that may be applicable in the embodiments of the present invention include conductive carbon powders, such as carbon blacks, including acetylene blacks, natural graphites, synthetic graphites, including expanded or exfoliated graphites, and combinations thereof. Other forms of conductive carbon include carbon nanofibers, multi-walled and single-walled carbon nanotubes, and various other forms of caged carbons.

In a fourth embodiment, the nano-lithium-ion battery includes an anode comprising about 75 weight percent to about 90 weight percent lithium titanium oxide nanoparticles, about 1 weight percent to about 5 weight percent of a conductive carbon, and a synthetic resin comprising at least one thermoplastic; a cathode comprising about 70 weight percent to about 95 weight percent lithium cobalt oxide, about 1 weight percent to about 6 weight percent of a conductive carbon, and a synthetic resin comprising at least one thermoplastic; a separator comprising about 2 weight percent to about 5 weight percent of silicon dioxide nanoparticles, and a synthetic resin comprising at least one thermoplastic; and an electrolyte.

Polyvinylidene fluoride and polyhexafluoropropylene are two types of synthetic thermoplastics that are applicable to the embodiments of the present invention. Dibutyl phthalate is a type of synthetic plasticizer or softening/flow-promoting agent for the synthetic thermoplastics. A solvent is introduced to mix the components; a common organic solvent used for such purposes is acetone.

In a preferred embodiment, the cathode includes about 70 weight percent to about 95 weight percent lithium cobalt oxide (LiCoO₂), about 1 weight percent to about 6 weight percent of a conductive carbon, and a synthetic resin including at least one thermoplastic. For example, the synthetic resin including the at least one thermoplastic may include about 2 weight percent to about 15 weight percent of polyvinylidene fluoride (PVDF), about 0.5 weight percent to about 4 weight percent of polyhexafluoroproplene (PHFP), and about 1.5 weight percent to about 15 weight percent of dibutyl phthalate (DBP). Acetone may be included as an organic solvent.

In a preferred embodiment, the anode includes about 75 weight percent to about 90 weight percent lithium titanium oxide nanoparticles (Li₄Ti₅O₁₂), about 1 weight percent to about 5 weight percent of a conductive carbon, and a synthetic resin including at least one thermoplastic. For example, the synthetic resin including the at least one thermoplastic may include about 2 weight percent to about 18 weight percent of polyvinylidene fluoride (PVDF), about 0.5 weight percent to about 5 weight percent of polyhexafluoroproplene (PHFP), and about 6.5 weight percent to about 12 weight percent of dibutyl phthalate (DBP). Acetone may be included as an organic solvent.

In a preferred embodiment, the separator includes about 2 weight percent to about 5 weight percent of silicon dioxide nanoparticles and a synthetic resin including at least one thermoplastic. For example, the synthetic resin including the at least one thermoplastic may include about 25 weight percent to about 50 weight percent of polyvinylidene fluoride (PVDF), about 5 weight percent to about 10 weight percent of polyhexafluoroproplene (PHFP), and about 28 weight percent to about 60 weight percent of dibutyl phthalate (DBP). Acetone may be included as an organic solvent. The silicon dioxide nanoparticles may be nano gas status silicon dioxide. The separator including the silicon dioxide nanoparticles has good stability under high temperature conditions to prevent short circuits inside the nano-lithium-ion battery, thus improving the safety of the battery.

In the preferred embodiments, the electrolyte includes ethylene (EC), diethyl carbonate (DMC) and ethyl methyl carbonate (EMC) in equal proportions (1:1:1).

In other embodiments, the nano-lithium-ion battery includes a cuprum foil material that is put together with the anode material to form an anode assembly, and an aluminum foil material that is put together with the cathode material to form a cathode assembly. In the preferred embodiments, the cuprum foil material and the aluminum foil material are treated with a treatment slurry formed by mixing about 70 weight percent to about 90 weight percent of a macromolecule glue that can be melted by heating with about 5 weight percent to about 20 weight percent of isopropylalcohol and about 5 weight percent to about 10 weight percent of a conductive carbon.

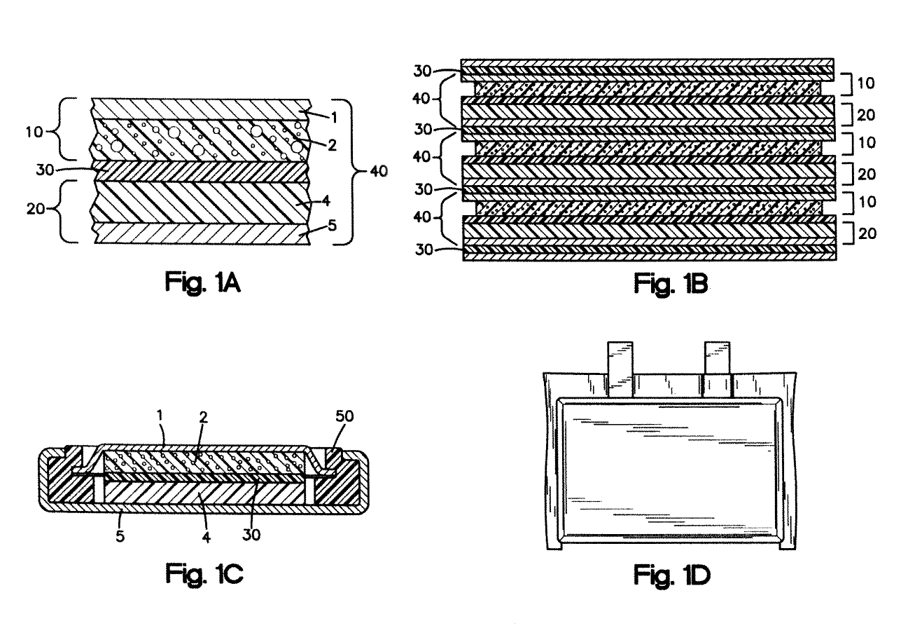

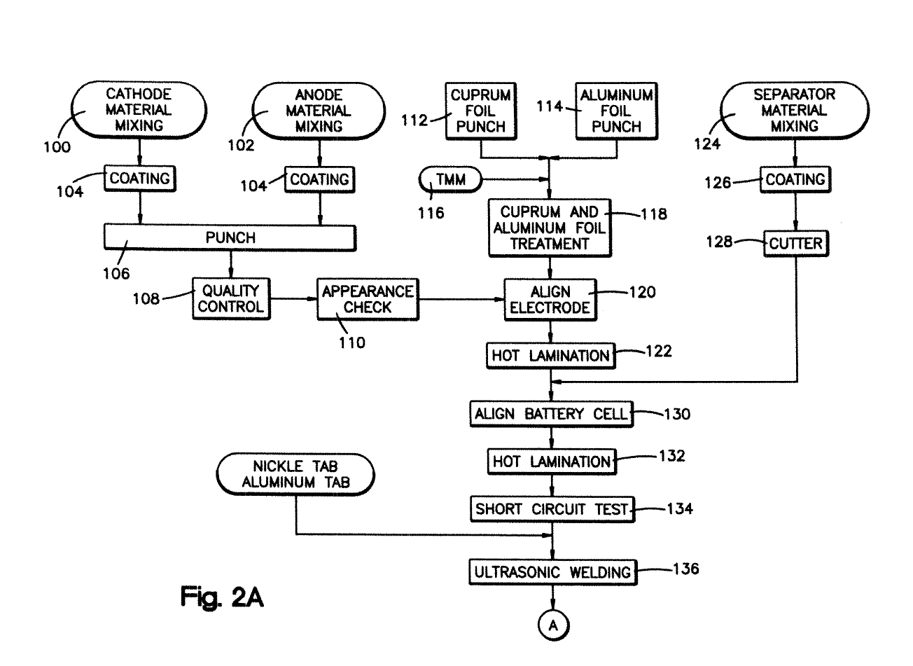

FIG. 1A shows a cross section of the laminated layered structure of a nano-lithium-ion battery according to an exemplary embodiment of the present invention. The nano-lithium-ion battery includes an anode assembly 10, a separator 30,and a cathode 20, which form a unit 40. The anode assembly 10, which includes a negative electrode collector 1 and a negative electrode layer 2, may be formed according to the methods of the invention described below. In preferred embodiments, the negative electrode collector 1 is a cuprum foil material, and the negative electrode layer 2 is a carrier coated with a slurry of an anode material, where the anode material includes lithium titanium oxide nanoparticles. The cathode assembly 20, which includes a positive electrode layer 4 and a positive electrode collector 5, may also be formed according to the methods of the invention described below. In preferred embodiments, the positive electrode collector 5 is an aluminum foil material, and the positive electrode layer 4 is a carrier coated with a slurry of a cathode material. The cathode material may also comprise lithium cobalt oxide and a conductive carbon. In preferred embodiments, the separator 30 includes silicon dioxide nanoparticles. An electrolyte included in the separator 30 facilitates the transfer of charge carriers between the anode assembly 10 and the cathode assembly 20.

In other embodiments, the nano-lithium-ion battery may be a multi-layer laminate, a combination of collectors with layers on both sides or a rolled laminate. FIG. 1B illustrates a multi-layer laminate structure, formed of several stacked units 40 with a layer of the separator 30 interspersed between each unit 40.

The nano-lithium-ion battery according to the present invention may have a conventional configuration, where an electrode laminate or rolled laminate is sealed in, for example, a metal case, a resin case, or a laminate film made of a metal foil such as an aluminum foil and a synthetic resin film. The nano-lithium-ion battery may be made to any desired shape, including, but not limited to, a cylindrical shape, a prismatic shape, a coin configuration or a sheet. FIG. 1C illustrates a nano-lithium battery having a coin configuration, where the negative electrode collector 1 and the positive electrode collector 5 are electrically insulated by a gasket 50. FIG. 1D illustrates an alternative embodiment of the nano-lithium battery, which has a rectangular or sheet configuration.

Methods of Making the Nano-Lithium Battery

The embodiments of the present invention also provide methods of making the nano-lithium-ion batteries. The methods disclosed herein provide the benefits of simplicity, and high yields of the finished battery goods, as compared to other processes. The methods of the embodiments of the present invention also require lower capital investment and lower production costs.

In a first embodiment, the method of making the nano-lithium-ion battery includes the steps of: (a) hot laminating a cathode assembly comprising an aluminum foil material and a carrier coated with a slurry of a cathode material; (b) hot laminating an anode assembly comprising a cuprum foil and a carrier coated with a slurry of an anode material, wherein the anode material comprises lithium titanium oxide nanoparticles; (c) hot laminating a unit comprising the anode assembly, the cathode assembly, and a separator, wherein the separator comprises silicon dioxide nanoparticles; and (d) introducing an electrolyte into the unit, thereby providing a nano-lithium-ion battery.

In a second embodiment, the method of making the nano-lithium-ion battery includes the steps of: (a) punching a carrier coated with an anode slurry to conform to a pre-determined battery shape, wherein the anode slurry comprises lithium titanium oxide nanoparticles; (b) assembling the shaped anode slurry with a cuprum foil material to form a cathode assembly; (c) treating the anode assembly using hot lamination; (d) punching a carrier coated with a cathode slurry to conform to a pre-determined battery shape; (e) assembling the shaped cathode slurry with an aluminum foil material to form a cathode assembly; (f) treating the cathode assembly using hot lamination; (g) hot laminating a unit comprising the anode assembly, the cathode assembly, and a separator, wherein the separator comprises silicon dioxide nanoparticles; and (h) introducing an electrolyte into the unit, thereby providing a nano-lithium-ion battery.

In a third embodiment, the method of making the nano-lithium-ion battery includes the steps of: (a) providing a shaped cuprum foil; (b) treating the shaped cuprum foil with a treatment slurry to provide a treated cuprum foil, wherein the treatment slurry comprises a glue; (c) assembling the treated cuprum foil with a shaped anode material to form an anode assembly, wherein the shaped anode material comprises lithium titanium oxide nanoparticles; (d) hot laminating the anode assembly at a temperature approximately equal to or greater than the melting temperature of the glue; (e) providing a shaped aluminum foil; (f) treating the shaped aluminum foil with a treatment slurry to provide a treated aluminum foil, wherein the treatment slurry comprises a glue; (g) assembling the treated aluminum foil with a shaped cathode material to form a cathode assembly; (h) hot laminating the cathode assembly at a temperature approximately equal to or greater than the melting temperature of the glue; (i) hot laminating a unit comprising the anode assembly, the cathode assembly, and a separator at a temperature approximately equal to or lower than the melting temperature of the glue, wherein the separator comprises silicon dioxide nanoparticles; and (j) introducing an electrolyte into the unit, thereby providing a nano-lithium-ion battery.

In a preferred embodiment, the method of manufacturing the nano-lithium-ion batteries includes, but is not limited to, the following steps:
making the cathode material slurry;
making the anode material slurry;
making the separator material slurry;
putting the cathode material slurry, the anode material slurry, and the separator material slurry separately on a carrier;
punching the carrier having the cathode material, the anode material and the separator material to conform to the desired battery size and shape;
punching the foil materials cuprum and aluminum foil materials separately to conform to the desired battery size and shape;
using a treatment material slurry to treat the shaped cuprum and aluminum foil materials;
assembling the cuprum foil material with the anode material to form an anode assembly, and hot laminating the anode assembly using a hot lamination machine at a temperature approximately equal to or greater than the melting temperature of a glue in the treatment material slurry;
assembling the aluminum foil material with the cathode material to form a cathode assembly, and hot laminating the cathode assembly using a hot lamination machine at a temperature approximately equal to or lower than the melting temperature of the glue in the treatment material slurry;
assembling the anode assembly, the cathode assembly, and the separator material to form a unit;
producing a battery cell unit by hot laminating the unit;
welding an outer electrode (a metal line) to the aluminum foil material of the cathode assembly using hot lamination;
welding an outer electrode to the cuprum foil material of the anode assembly using hot lamination;
putting the welded battery into a liquid for extraction;
wrapping the battery cell using a composite aluminum foil;
introducing the electrolyte into the battery;
checking the performance of the battery; and
using degas sealing or vacuum sealing to produce the finished goods.

In a preferred embodiment, the anode material slurry is made by mixing together about 75-90 weight percent (wt %) lithium titanium oxide nanoparticles, about 1-5 wt % of a conductive carbon, about 2-18 wt % polyvinylidene fluoride, about 0.5-5 wt % polyhexafluoropropylene, about 6.5-12 wt % dibutyl phthalate and acetone. A carrier is coated with the anode material slurry, and is cut to conform to the desired battery size and shape. A cathode material slurry is made by mixing together about 70-95 wt % lithium cobalt oxide, about 1-6 wt % of a conductive carbon, about 2-15 wt % polyvinylidene fluoride, about 0.5-4 wt % polyhexafluoropropylene, and about 1.5-15 wt % dibutyl phthalate, with acetone. A carrier is coated with the cathode material slurry, and then cut to conform to the desired battery size and shape. Cuprum foil material and aluminum foil material are separately cut to conform to the desired battery size and shape. The cuprum and aluminum foil materials are then treated using a treatment material slurry, which is made by mixing about 70-90 wt % of a macromolecule glue that can be melted by heating, with about 5-20 wt % isopropylalcohol, and about 5-10 wt % of a conductive carbon. The cuprum foil material is assembled with the anode material slurry to form the anode assembly. The aluminum foil material is assembled with the cathode material slurry to form the cathode assembly. The anode assembly and the cathode assembly are laminated in the temperature range of 130° C. to 150° C. using a hot lamination machine.

The battery cell unit is produced through hot lamination of a unit comprising the anode assembly, the cathode assembly, and a separator at a temperature from 110° C. to 120° C. The separator is made by coating a carrier with a separator material slurry, which is made by mixing together about 25-50 wt % polyvinylidene fluoride, about 5-10 wt % polyhexafluoropropylene, about 2-5 wt % silicon dioxide nanoparticles, about 28-60 wt % dibutyl phthalate and acetone, and then cutting the separator material to conform to the desired battery size and shape.

An ultrasonic welding machine is used to weld the outer electrodes of the battery with the aluminum foil of the cathode assembly and the cuprum foil of the anode assembly. The welded battery cell is put into methanol liquid for extraction, wrapped using composite aluminum foil, and an electrolyte is introduced. The performance of the battery is checked, and then the battery is sealed under vacuum conditions to produce the finished battery goods.

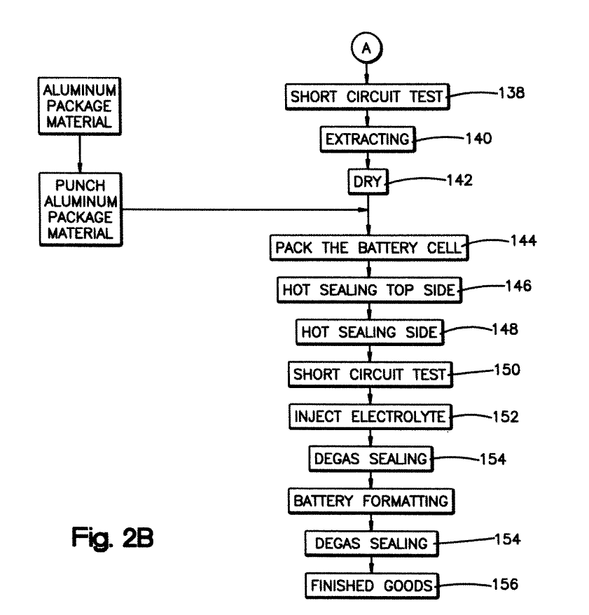

FIGS. 2A and 2B illustrate a technical flow chart of an industrial process based on an exemplary embodiment of a manufacturing process for making the nano-lithium battery. As shown in FIG. 2A, the cathode material 100 and the anode material 102 are mixed separately and coated onto a carrier 104. The coated carriers are punched 106 to provide electrodes that conform to the desired size and shape of the battery. Quality control (QC) 108 tests and configuration tests 110, e.g., appearance checks, are then performed on the shaped electrodes. The cuprum foil material 112 anid the aluminum foil material 114 are also separately punched to the desired size and shape of the battery. The cuprum foil material and the aluminum foil material are then treated 118 with the treatment material slurry 116, which includes a macromolecule glue. (The letters “TMM” refer to “treatment material mixing.”) The cuprum foil material is then put together with the anode material to form an anode assembly 120, and the aluminum foil material is put together with the cathode material to form a cathode assembly 120. The anode assembly and the cathode assembly are each separately welded by hot lamination 122. The separator material is mixed 124, coated onto a carrier 126, and punched to conform to the desired size and shape to form the separator of the battery 128. The anode assembly, the cathode assembly and the separator are aligned to form a unit of the battery cell 130, which is then hot laminated 132. Short circuit test 134 are then performed on the laminated unit. Nickel tabs are point welded, e.g., using ultrasonic welding 136, to the anode assembly to form an outer circuit electrode of the battery. Similarly, aluminum tabs are point welded 136 to the cathode assembly to form the other outer circuit electrode of the battery. As shown in FIG. 2B, another short circuit test 138 is performed. In the final steps of the process, the assembled unit is placed into a methanol liquid for a period of time for extraction 140, and the assembled unit is then dried 142. An aluminum foil package material is prepared to conform to the desired shape and size, the battery cells are packed 144, the top and sides of the battery are hot-sealed 146, 148, and a short circuit test 150 is performed to test the performance of the battery. The electrolyte 152 is injected into the battery, and the battery is sealed by degas sealing 154 to form the finished goods 156.

Compared to other lithium-ion battery manufacturing methods, the above-described embodiments of the present invention provide batteries with increased safety and faster charge/discharge capabilities. Table 1 below provides a comparison of the properties of a nano-lithium battery according to a preferred embodiment of the present invention (Column A) to other lithium-ion batteries (Column B).

TABLE 1

| Properties of the Battery | A | B |
|---|---|---|
| Size | Ultra-thin (capable of | No thinner than 2 mm |
| | 0.5 mm thickness) | |
| Memory | Very weak | Very weak |
| Short Circuit Test | Voltage changed to | Heat, deformation |
| | 0 V in little to no time, | |
| | no deformation | |
| Over-charge Test | Temperature <60° C. | Temperature |
| | | >90° C., fire |
| Working Temperature | −20° C. to 50° C. | 20° C. to 50° C. |
| Effect on Environment | No pollution | Pollution |
| Electrolyte Leak | No | Yes, at certain levels |
| Battery Recycle Life | 700-1400 times | 300-600 times |
| Self-Discharge Level | <5% | <7% |
| (per month) | | |
| Poison | No | Yes |
| Collision Test | No leak | Leak |
| Largest Charge Current | 3C^{†} | 1C^{†} |
| Largest Discharge | 6C^{†} | 3C^{†} |
| Current | | |

^{†}“C” denotes the capacity of the battery. For example, if the capacity of the battery is 650 MAh, then 1C current is 0.65 A and 6C is 3.9 A.

### EXAMPLES¹

### Example 1

A carrier is coated with a cathode material slurry, which is made by mixing 95 wt % lithium cobalt oxide (LiCoO₂), 1 wt % conductive carbon, 2 wt % polyvinylidene fluoride (PVDF), 0.5 wt % polyhexafluoropropylene (PHFP), 1.5 wt % dibutyl phthalate (DBP), and adding acetone as organic solvent. A carrier is coated with an anode material slurry, which is made by mixing 90 wt % nano lithium titanium oxide (Li₄Ti₅O₁₂), 1 wt % conductive carbon, 2 wt % polyvinylidene fluoride (PVDF), 0.5 wt % polyhexafluoropropylene (PHFP), 6.5 wt % dibutyl phthalate (DBP) and adding acetone as organic solvent. A carrier is coated with a separator material slurry, which is made by mixing 45 wt % polyvinylidene fluoride (PVDF), 7 wt % polyhexafluoropropylene (PHFP), 5 wt % nano gas status silicon dioxide, 38 wt % dibutyl phthalate (DBP) and adding acetone as an organic solvent.
¹Pursuant to MPEP, Section 608.01(p), Completeness, the Examples herein are being provided to assist someone of ordinary skill in the art to understand the subject matter of a number of the embodiments of the present invention. These examples are not intended to limit the scope of the claims and should not be interpreted as limiting the scope of any of the claims.

The carrier having the anode material slurry, the cathode material slurry, and the separator material slurry are preferably separately cut to conform to the desired battery size and shape. Cuprum and aluminum foil materials are preferably separately cut to conform to the desired battery size and shape, and are each preferably treated using a treatment material slurry.

The treated cuprum foil material is preferably put together with the anode material slurry to form an anode assembly, while the aluminum foil material is preferably put together with the cathode material slurry to form a cathode assembly. A hot lamination machine operating in the temperature range of 130° C. to 150° C. is preferably used to hot laminate the anode assembly and the cathode assembly separately. A battery cell unit is preferably produced by hot laminating the anode assembly, the cathode assembly, and the separator at 110° C. to 120° C. An ultrasonic welding machine is preferably used to weld the outer electrodes of the battery to the aluminum foil of the cathode assembly, and the cuprum foil of the anode assembly. The welded battery cell unit is preferably placed in methanol liquid for extraction. The battery cell unit is preferably wrapped using composite aluminum foil. The electrolyte is preferably introduced into the battery, and the battery performance is preferably checked before the battery is preferably vacuum sealed to produce a finished product.

### Example 2

The cathode material is preferably made by mixing 70 wt % lithium cobalt oxide (LiCoO₂), 5 wt % of a conductive carbon, 15 wt % polyvinylidene fluoride (PVDF), 3 wt % polyhexafluoropropylene (PHFP), and 7 wt % dibutyl phthalate (DBP), with acetone. The anode material is preferably made by mixing 75 wt % lithium titanium oxide nanoparticles (Li₄Ti₅O₁₂), 5 wt % of a conductive carbon, 10 wt % polyvinylidene fluoride (PVDF), 1 wt % polyhexafluoropropylene (PHFP), and 9 wt % dibutyl phthalate (DBP), with acetone. The separator is preferably made by mixing 25 wt % polyvinylidene fluoride (PVDF), 7 wt % polyhexafluoropropylene (PHFP), 5 wt % nano gas status silicon dioxide, and 55 wt % dibutyl phthalate (DBP), with acetone. The finished battery product is preferably made according to the steps described in Example 1.

### Example 3

The cathode material is preferably made by mixing 80 wt % lithium cobalt oxide (LiCoO₂), 2 wt % conductive carbon, 10 wt % polyvinylidene fluoride (PVDF), 2 wt % polyhexafluoropropylene (PHFP), and 6 wt % dibut,yl phthalate (DBP), with acetone added as an organic solvent. The anode material is preferably made by mixing 85 wt % nano lithium titanium oxide (Li₄Ti₅O₁₂), 2 wt % conductive carbon, 5 wt% polyvinylidene fluoride (PVDF), 1 wt % polyhexafluoropropylene (PHFP), 7 wt % dibutyl phthalate (DBP), with acetone added as an organic solvent. The separator is preferably made by mixing 50 wt % polyvinylidene fluoride (PVDF), 8 wt % polyhexafluoropropylene (PHFP), 5 wt % nano gas status silicon dioxide, 30 wt % dibutyl phthalate (DBP), with acetone added as an organic solvent. The treatment material slurry for the cuprum and aluminum foils is preferably made by mixing 90 wt % of a macromolecule glue that can be melted by heating, 5 wt % isopropylalcohol, and 5 wt % of a conductive carbon. The finished battery product is preferably made according to the steps described in Example 1.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims. In addition, the reciting of steps in the method claims provided below does not infer that such steps need to be performed in the order of steps as recited therein.

What is claimed is:

1. A nano-lithium-ion battery comprising:
an anode comprising lithium titanium oxide nanoparticles;
a cathode;
a separator; and
an electrolyte.

2. A nano-lithium-ion battery comprising:
an anode;
a cathode;
a separator comprising silicon dioxide nanoparticles; and
an electrolyte.

3. A nano-lithium-ion battery comprising:
an anode comprising lithium titanium oxide nanoparticles and a conductive carbon;
a cathode comprising lithium cobalt oxide and a conductive carbon;
a separator comprising silicon dioxide nanoparticles; and
an electrolyte.

4. A nano-lithium-ion battery comprising:
an anode comprising:
about 75 weight percent to about 90 weight percent lithium titanium oxide nanoparticles, about 1 weight percent to about 5 weight percent of a conductive carbon, and a synthetic resin comprising at least one thermoplastic;
a cathode comprising:
about 70 weight percent to about 95 weight percent lithium cobalt oxide, about 1 weight percent to about 6 weight percent of a conductive carbon, and a synthetic resin comprising at least one thermoplastic;
a separator comprising:
about 2 weight percent to about 5 weight percent of silicon dioxide nanoparticles, and a synthetic resin comprising at least one thermoplastic; and
an electrolyte.

5. A method of making a nano-lithium-ion battery, comprising the steps of:
hot laminating a cathode assembly comprising an aluminum foil material and a carrier coated with a slurry of a cathode material;
hot laminating an anode assembly comprising a cuprum foil material and a carrier coated with a slurry of an anode material, wherein the anode material comprises lithium titanium oxide nanoparticles;
hot laminating a unit comprising the anode assembly, the cathode assembly, and a separator, wherein the separator comprises silicon dioxide nanoparticles; and
introducing an electrolyte into the unit.

6. A method of making a nano-lithium-ion battery, comprising the steps of:
punching a carrier coated with an anode slurry to conform to a pre-determined battery shape, wherein the anode slurry comprises lithium titanium oxide nanoparticles;
assembling the shaped anode slurry with a cuprum foil material to form a cathode assembly;
treating the anode assembly using hot lamination;
punching a carrier coated with a cathode slurry to conform to a pre-determined battery shape;
assembling the shaped cathode slurry with an aluminum foil material to form an cathode assembly;
treating the cathode assembly using hot lamination;
hot laminating a unit comprising the anode assembly, the cathode assembly, and a separator, wherein the separator comprises silicon dioxide nanoparticles; and
introducing an electrolyte into the unit.

7. A method of making a nano-lithium-ion battery, comprising the steps of:
providing a shaped cuprum foil;
treating the shaped cuprum foil with a treatment slurry to provide a treated cuprum foil, wherein the treatment slurry comprises a glue;
assembling the treated cuprum foil with a shaped anode material to form an anode assembly, wherein the shaped anode material comprises lithium titanium oxide nanoparticles;
hot laminating the anode assembly at a temperature approximately equal to or greater than the melting temperature of the glue;
providing a shaped aluminum foil;
treating the shaped aluminum foil with a treatment slurry to provide a treated aluminum foil, wherein the treatment slurry comprises a glue;
assembling the treated aluminum foil with a shaped cathode material to form an cathode assembly;
hot laminating the cathode assembly at a temperature approximately equal to or greater than the melting temperature of the glue;
hot laminating a unit comprising the anode assembly, the cathode assembly, and a separator at a temperature approximately equal to or lower than the melting temperature of the glue, wherein the separator comprises silicon dioxide nanoparticles; and
introducing an electrolyte into the unit.
